(19) United States
(12) Patent Application Publication
(10) Pub. No.: US 2007/0208857 A1
(43) Pub. Date: Sep. 6, 2007

(54) SYSTEM, METHOD, AND COMPUTER-READABLE MEDIUM FOR GRANTING TIME-BASED PERMISSIONS

(75) Inventors: Tim L. Danner, Houston, TX (US); David F. Perdue, Austin, TX (US); Kenton R. Erickson, The Woodlands, TX (US)

Correspondence Address: HAYNES AND BOONE, LLP, 901 MAIN STREET, SUITE 3100, DALLAS, TX, 75202, US

(73) Assignee: NETIQ CORPORATION, San Jose, CA (US)

(21) Appl. No.: 11/420,125

(22) Filed: May 24, 2006

Related U.S. Application Data
(60) Provisional application No. 60/775,146, filed on Feb. 21, 2006.

(51) Int. Cl. G06F 15/173

(52) U.S. Cl. 709/226

(57) ABSTRACT

A system, method, and computer-readable medium for delegating access permissions in a network system are provided.

### CROSS REFERENCE TO RELATED APPLICATIONS

This application claims priority to U.S. provisional patent application Ser. No. 60/775,146, attorney docket number 37894.5, entitled, SYSTEM, METHOD, AND COMPUTER-READABLE MEDIUM FOR GRANTING TIME-BASED PERMISSIONS AND JUST-IN-TIME ACCESS THROUGH DYNAMIC GROUP MEMBERSHIP, filed Feb. 21, 2006, by Danner, et al, the disclosure of which is incorporated herein by reference.

This application is related to the following co-pending applications: 1) U.S. Patent Application No. 60/754,373 attorney docket no. 37894.3 filed on Dec. 27, 2005; 2) U.S. patent application No. ______ attorney docket no. 37894.4 filed on ______; and 3) U.S. patent application No. ______ attorney docket no. 37894.6 filed on ______, the disclosures of which are incorporated herein by reference.

### BACKGROUND

Embodiments disclosed herein relate to, in general, network systems and, in particular, to operator permission mechanisms deployed in a network system.

### BRIEF DESCRIPTION OF THE DRAWINGS

Aspects of the present disclosure are best understood from the following detailed description when read with the accompanying figures, in which:

FIG. 1 is a diagrammatic representation of a network system in which embodiments disclosed herein may be implemented;

FIG. 2 is a diagrammatic representation of an exemplary computer system that may be configured for delegation of conditional time-based permissions and conditional permission authorizations in accordance with embodiments disclosed herein;

FIG. 3 is a diagrammatic representation of an embodiment of an exemplary computer system that may be configured as a client in a network system;

FIG. 4A is a diagrammatic representation of an embodiment of a change administrator server configuration that facilitates entitlement delegation and configuration in accordance with embodiments disclosed herein;

FIG. 4B is a diagrammatic representation of an embodiment of a operator console server software configuration that facilitates receipt, processing, and authorization of operator access requests;

FIG. 5 is a flowchart depicting processing of an embodiment of an entitlement delegation routine for allocating entitlements;

FIG. 6 is a flowchart of an entitlement schedule configuration subroutine for assignment of a permission schedule to an entitlement;

FIG. 7 depicts a diagrammatic representation of a table in which entitlements implemented in accordance with embodiments disclosed herein may be maintained;

FIG. 8 is a flowchart depicting processing steps of an authorization routine for authorizing explicit operator access requests in accordance with embodiments disclosed herein;

FIG. 9 is a flowchart of a schedule evaluation subroutine for evaluating an entitlement schedule in accordance with embodiments disclosed herein; and

FIG. 10 is a flowchart depicting processing steps of an authorization routine for processing generic access requests in accordance with embodiments disclosed herein.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Information Technology (IT) operators may require various permissions on servers to perform tasks in a network system. However, the same administrative permissions are not required at all times. In conventional practice, IT operators obtain or are otherwise assigned, at all times, a superset of all of the permissions they are likely to need at any time. This manner of access permission is often undesirably excessive. Moreover, conventional permission schemes implemented in a network environment are either granted or not granted. That is, an IT operator is either granted a permission or is not granted the permission. If an operator has a permission granted thereto, e.g., an access permission, an operational permission, or the like, the operator may perform any action(s) allowed by the permission until that permission is revoked. No concept of conditional permissions is provided in conventional administrative permission mechanisms.

Assignment of operator permissions may be performed according to one of two general mechanisms. An administrator responsible for assignment of permissions may either grant permissions broadly or manually grant and revoke permissions when necessary. Neither option is ideal, broad permissions lead to a lack of control, and manual permission granting is burdensome, error-prone, and time consuming.

In accordance with embodiments disclosed herein, an operator may be granted a conditional permission by an administrative manager. As referred to herein, a primary administrator is a network personnel authorized to grant entitlements to operators. As referred to herein, an operator is an administrator or other personnel that has entitlements granted thereto by the primary administrator. An entitlement, as referred to herein, defines an operational permission that may include a mapping of an operator to one or more network entities, such as a server, network infrastructure, or the like, associated operational privilege(s) allowed to be performed by the operator on the one or more network entities, and one or more schedules that define a time-basis on which the privileges are allowed to be performed on the associated network entities by the particular operator. When an operator requests access to a server with a certain set of privileges, the request is compared to entitlements delegated for the operator. If the request conforms to a defined entitlement and the current time falls with that entitlement's schedule, access is granted; otherwise access is denied.

In accordance with an embodiment, an entitlement may be delegated as a conditional or unconditional entitlement. An unconditional entitlement comprises an entitlement with no time-based schedule restrictions and that, once granted, provides a permission that endures indefinitely. An unconditional entitlement will remain valid unless the entitlement is subsequently revoked, e.g., by an administrative authority. Entitlements may default to an unconditional type such that any entitlement is categorized as unconditional unless specifically designated otherwise.

A conditional entitlement comprises an entitlement that has time-based restrictions associated therewith. Two general conditional entitlements are disclosed herein although various other conditional entitlements may be implemented without departing from the disclosed embodiments. As referred to herein, a conditional entitlement is said to be active if an access request conforming to the conditional entitlement is submitted within an allowable time frame defined by the time-based restrictions of the entitlement. The conditional entitlement is said to be inactive if an access request conforming to the conditional entitlement is submitted at a time that is not within an allowable time frame defined by the time-based restrictions of the entitlement.

A recurring with time-limit entitlement comprises a conditional entitlement that may be delegated indefinitely but that includes time-based permission limits. For example, a recurring with time-limit entitlement may be granted to an operator that provides one or more operational privileges on one or more network entities such that the delegated operational privileges are valid only at particular times of the day and/or on specific days of the week. In other implementations, a recurring with time-limit entitlement may be granted with a pre-defined number of recurrences rather than indefinite recurrence.

A one-time entitlement comprises a conditional entitlement that provides an operational privilege for a specific date, duration, or other interval. A one-time entitlement may also define a limited time range on the day for which the entitlement is delegated. A one-time entitlement does not include any privilege recurrence.

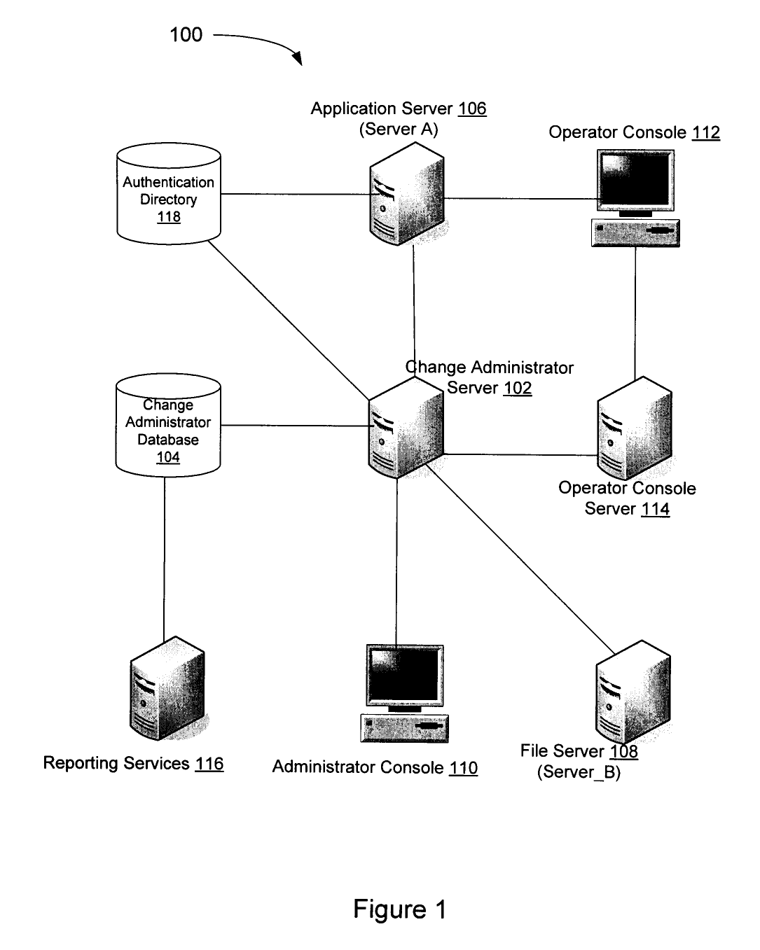

FIG. 1 is a diagrammatic representation of a network system 100 in which embodiments disclosed herein may be implemented. Network system 100 is a network of computers and requisite network infrastructure and may be implemented as, for example, a local area network that provides a medium used to provide communication links between various devices and computers connected together within network system 100. Network device interconnections may be implemented as wireline or wireless links. Of course, network system 100 also may be implemented as any number of different types of networks, such as, for example, an intranet, a wide area network (WAN), or any other suitable network configuration. FIG. 1 is intended as an example, and not as an architectural limitation, of a network system in which embodiments described herein may be implemented.

In the depicted example, system 100 includes a change administrator server 102 from which entitlements are delegated by a primary administrator. Pursuant to providing conditional entitlements, change administrator server 102 may include or interface with a change administrator database 104. Change administrator database 104 maintains a table or other data structure that stores entitlements that may include an operator identifier, a network entity, an optional operational privilege, and a schedule. Change administrator database 104 is the repository of configuration and state data for change administrator server 102.

In the present example, system 100 includes two managed servers, an application server 106 and a file server 108, on which operational privileges may be granted to operators in accordance with conditional privilege delegations defined by entitlements maintained in database 104. In the present example, servers 106 and 108 each have a respective identifier or name of Server_A and Server_B assigned thereto. System 100 may include an administrator console 110 from which the primary administrator delegates entitlements to operators that may access system entities or nodes via one or more operator consoles 112. Operator console 112 is used by an operator to request access to a server and one or more tools, e.g., management or administrative applications, for use on the selected server.

An operator console server 114 may be configured to communicatively couple with operator console 112 and database 104. Operator console server 114 may be configured to receive access requests from operator console 112 and evaluate records in database 104 to determine whether to grant or deny the access request. Operator console server 114 may provide a menu or other user-selectable options to an operator at operator console 112 in response to operator console 112 connecting with console server 114. For example, operator console server 114 may generate and transmit a web page including a menu of servers and/or applications to which the operator is granted access. In one implementation, operator console server 114 obtains an identification of an operator, such as a user name, when operator console 112 connects with operator console server 114. Operator console server 114 may then interrogate database 104 to identify any network entities, and operator privileges associated therewith, to which the operator is currently permitted access.

While operator console server 114 is depicted as a distinct entity within system 100, operator console server 114 may be integrated with, for example, change administrator server 102. Network system 100 may include various other entities, such as a reporting services console 116 that interfaces with database 104. Reporting services console 116 may be configured to perform auditing services on granted access permissions, access denials, access violations, and the like. Additionally, system 100 may include an authentication directory 118, such as Active Directory™ manufactured by Microsoft Corporation, of Redmond, Wash., that maintains user or group accounts, referred to herein as proxy accounts, configured in accordance with entitlements maintained in database 104.

Administrator console 110 may be implemented as, for example, a Win32 application running on a network client adapted to configure and manage change administrator server 102. Administrator console 110 preferably provides various functions for creating and managing entitlements that are stored in database 104. Additionally, administrator console 110 may be adapted to configure launchable applications and may group launchable applications into toolkits that may be presented to an operator console. Various other functions may be provided by administrator console 110 that generally facilitate efficient management of system 100, such as displaying a summary of the current system status, adjustment of metadata fields, import and export of tools, toolkits, and entitlements that have been defined, or other suitable administrative functions.

Responsibilities of change administrator server 102 may include delegation, or set up, of entitlements, managing proxy accounts, monitoring operator sessions, auditing configuration and entitlement changes, sending selected event notifications by email, and proxying access to database 104 and authentication directory 118. Change administrator server 102 may also publish various performance counters.

Change administrator server 102 controls an account that it used for creating proxy accounts and may add created proxy accounts to proxy account groups. Change administrator server 102 may allocate entitlements for other administrators of any varying administrative capacity. In accordance with embodiments described herein, an operator having privileges delegated thereto by a primary administrator is not able to change the administrative configuration of change administrator server 102 and may not modify or set entitlements delegated thereto. Change administrator server 102 may be configured to report various events, including, for example, configuration changes, entitlement grants, license issues, etc., to an event log or entity, such as reporting services console 116.

In accordance with an embodiment, granting and revoking permissions to an operator may be made based on an entitlement schedule thereby reducing errors while maintaining tight privilege controls. As described herein, a system administrator can specify when to grant, deny, and revoke permissions, and the conditional permissions are automatically enforced based on time-based permission policies. Advantageously, the system administrator can control permissions while not having to remember or manually provide a permission allowance or revocation at a particular time. This mechanism may provide substantial savings in both time and money, reduce errors, and improve access controls.

In one embodiment, times may be presented in GMT or Universal Time to facilitate accommodation of servers in different time zones. For time-limited permissions, the time granularity may be, for example, implemented in half-hour increments, minute increments, or another suitable interval. If a user successfully obtains authorized access to a server in accordance with a conditional permission but doesn't log off the server prior to expiration of an end time of the conditional permission's time based policy, an event noting the policy violation may be generated. Preferably, the user is not forcibly logged out but instead may be notified of the time-based policy violation. However, in other embodiments, the user may be forcibly logged off of the server.

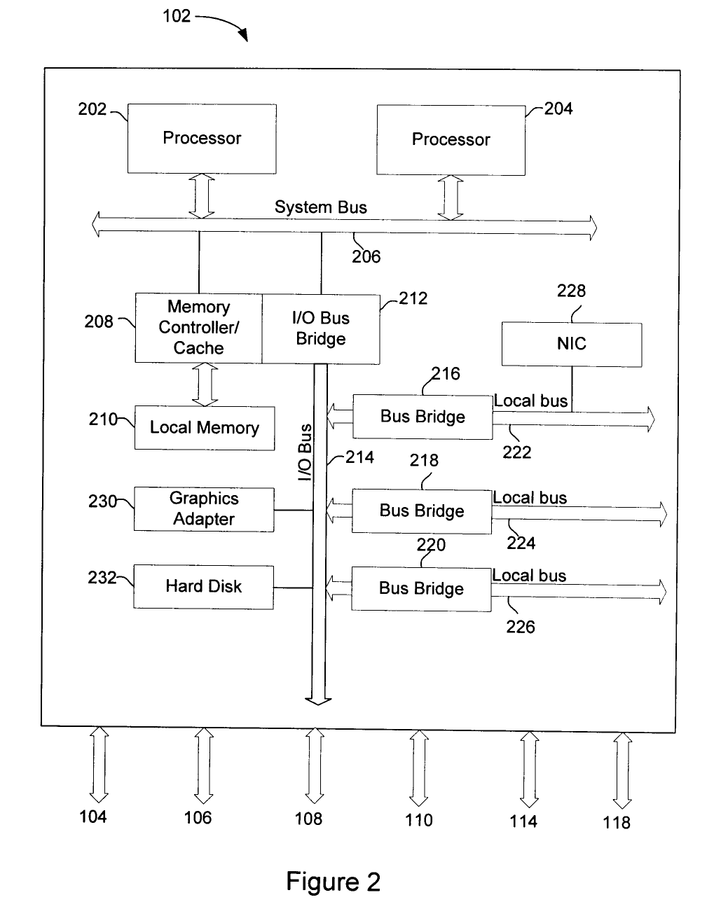

FIG. 2 is a diagrammatic representation of an exemplary change administrator server 102 that may be configured for delegation of conditional time-based permissions and permission authorizations in accordance with embodiments disclosed herein.

Server 102 may be a symmetric multiprocessor (SMP) system that includes a plurality of processors 202 and 204 connected to a system bus 206 although other single-processor or multi-processor configurations may be suitably substituted therefor. A memory controller/cache 208 that provides an interface to local memory 210 may also be connected with system bus 206. An I/O bus bridge 212 may connect with system bus 206 and provide an interface to an I/O bus 214. Memory controller/cache 208 and I/O bus bridge 212 may be integrated into a common component.

A bus bridge 216, such as a Peripheral Component Interconnect (PCI) bus bridge, may connect with I/O bus 214 and provide an interface to a local bus 222, such as a PCI local bus. Communication links to other network nodes of system 100 in FIG. 1 may be provided through a network interface card (NIC) 228 connected to local bus 222 through add-in connectors. Additional bus bridges 218 and 220 may provide interfaces for additional local buses 224 and 226 from which peripheral or expansion devices may be supported. A graphics adapter 230 and hard disk 232 may also be connected to I/O bus 214 as depicted.

Those of ordinary skill in the art will appreciate that the hardware depicted in FIG. 2 may vary. The depicted example is not intended to imply architectural limitations with respect to implementations of the present disclosure.

In accordance with embodiments disclosed herein, a primary administrator may log onto or otherwise access server 102. An entitlement delegation application implemented as computer-executable instructions maintained or accessed by server 102 may be executed, and a user interface may then be provided to the primary administrator, e.g., at administrator console 110. For example, server 102 may generate a web page or other data structure that is conveyed to administrator console 110 and that provides for prompts or other data input items for configuration of conditional entitlements.

Embodiments disclosed herein may be implemented as computer-executable instructions tangibly embodied on a computer-readable medium, such as local memory 210 or hard disk 232, that are run in conjunction with an operating system, such as a Unix operating system implemented as computer executable instructions executed by an instruction execution device, such as one or more of processors 202 and 204.

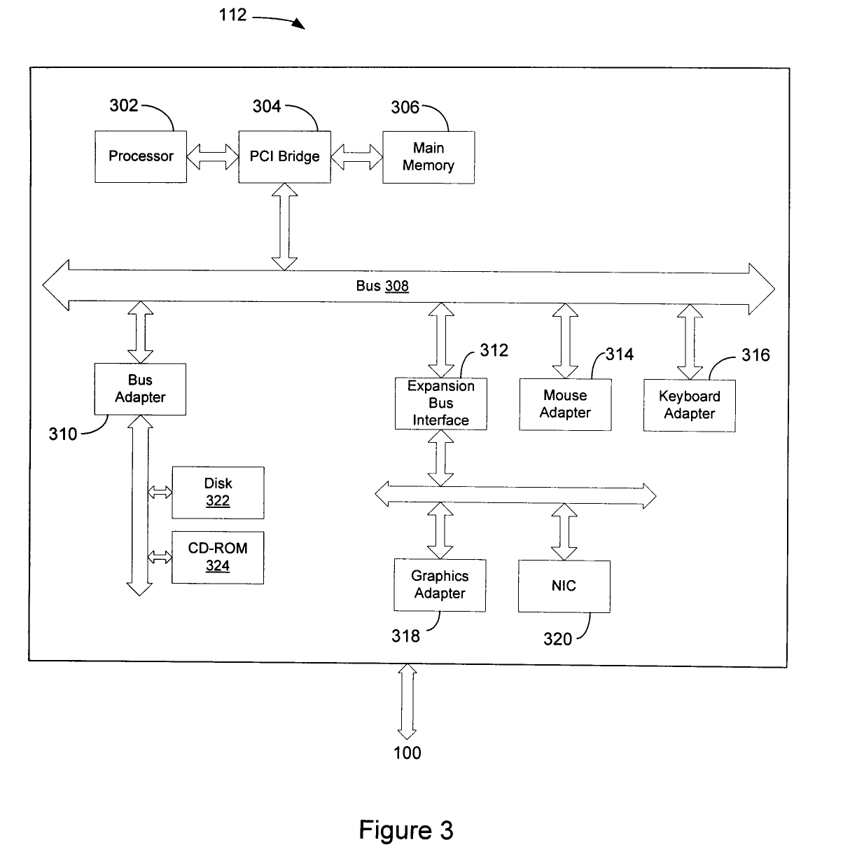

FIG. 3 is a diagrammatic representation of an exemplary embodiment of operator console 112 depicted in FIG. 1.

Code or instructions implementing operator console processes of embodiments disclosed herein may be located or accessed by console 112. In the illustrative example, console 112 employs a PCI local bus architecture, although other bus architectures, such as the Industry Standard Architecture (ISA), may be used. A processor system 302 and a main memory 306 are connected to a PCI local bus 308 through a PCI bridge 304. PCI bridge 304 also may include an integrated memory controller and cache memory for processor system 302. Additional connections to PCI local bus 308 may be made through direct component interconnection or through add-in connectors. In the depicted example, a small computer system interface (SCSI) host bus adapter 310, an expansion bus interface 312, a mouse adapter 314, and a keyboard adapter 316 are connected to PCI local bus 308 by direct component connection. In contrast, a graphics adapter 318 and a NIC 320 are connected to PCI local bus 308 via expansion bus interface 312 by add-in boards inserted into expansion slots. NIC 320 provides an interface for connecting console 112 with other devices in system 100 depicted in FIG. 1. Expansion bus interface 312 provides a connection for various peripheral devices. SCSI host bus adapter 310 provides a connection for a hard disk drive 322, and a CD-ROM drive 324. Typical PCI local bus implementations may support a plurality of PCI expansion slots or add-in connectors.

An operating system runs on processor system 302 and is used to coordinate and provide control of various components within console 112. Instructions for the operating system and applications or programs are located on storage devices, such as hard disk drive 322, and may be loaded into main memory 306 for execution by processor system 302.

In accordance with embodiments disclosed herein, an operator may submit a request for access to a network entity, such as application sever 106, file server 108, or another network node, by initiating a communication connection with operator console server 414. To this end, operator console 112 may be configured as a client of operator console server 114. Communication connections between operator console 112 and operator console server 114 may be made on the TCP/IP protocol suite, although other communication protocols may be suitably substituted therefor. Implementations of disclosed embodiments are not limited to any particular protocol and those described are provided only to facilitate an understanding of the embodiments.

In one embodiment, operator console 112 may be configured to convey an explicit access request to operator console server 114. In another embodiment, operator console 112 may be configured to convey a generic access request to operator console server 114. As referred to herein, an explicit access request comprises a request that specifies a particular network entity to which the operator desires access. As referred to herein, a generic access request does not include a specification of a particular network entity to which the operator desires access.

An explicit access request may include a request parameter that defines a particular network entity to which the operator seeks access. For example, operator console 112 may be configured with a client application that presents a user interface to the operator that includes a menu of server names for which the operator has entitlements configured therefor. For example, assume a particular operator has entitlements configured in database 104 that grant some form of access rights to both application server 106 and file server 108. In this instance, change administrator server 102 or another suitable entity may convey a client application, or data for display thereby, to operator console 112 that is adapted to display a menu including names of application server 106 and file server 108. Operator console 112 may connect with operator console server 114 in response to selection of one of the server names by the operator, and the operator console 112 may transmit an identity of the selected server and an identity of the operator in an explicit access request message to operator console server 114. Operator console sever 114, in response to receipt of the explicit access request, may interrogate change administrator database 104 with an identity of the operator and an identity of the selected server to which the operator seeks access. For example, operator console server 114 may formulate an SQL SELECT operation to retrieve records from database 104 that include the specified operator and server. On receipt of a record set from database 104, operator console server 114 may then evaluate the records to determine whether the operator currently has access rights to the selected server. Operator console server 114 may then generate a web page or other data structure that indicates the access rights, if any, currently available to the operator. Additionally, change administrator server 102 may configure a proxy account assigned to the operator that is used to enforce the current access permissions of the operator. The operator may then access the server, if any, identified as currently accessible by the operator.

A generic access request may exclude any identification of a particular network entity to which the operator seeks access and instead may simply indicate the operator wishes to be notified of what access permissions the operator may currently exercise. For example, operator console 112 may be configured with a client application that generates a generic access request, connects with operator console server 114, and transmits the generic access request thereto. The generic access request may, for example, include an identifier of the operator desiring access in network system 100. Operator console sever 114, in response to receipt of the generic access request, may interrogate change administrator database 104 with an identity of the operator. For example, operator console server 114 may formulate an SQL SELECT operation to retrieve records from database 104 that include the specified operator. On receipt of a record set from database 104, operator console server 114 may then evaluate the records to determine whether the operator currently has access rights to any servers or other entities in network system 100. Operator console server 114 may then generate a web page or other data structure that indicates the access rights, if any, currently available to the operator and transmit the web page to operator console 112. Additionally, change administrator server 102 may configure a proxy account assigned to the operator that is used to enforce the current access permissions of the operator. The operator may then access the server, if any, identified as currently accessible by the operator. In this manner, operator console 112 is notified of all available access rights currently allowed and may make a network entity selection accordingly.

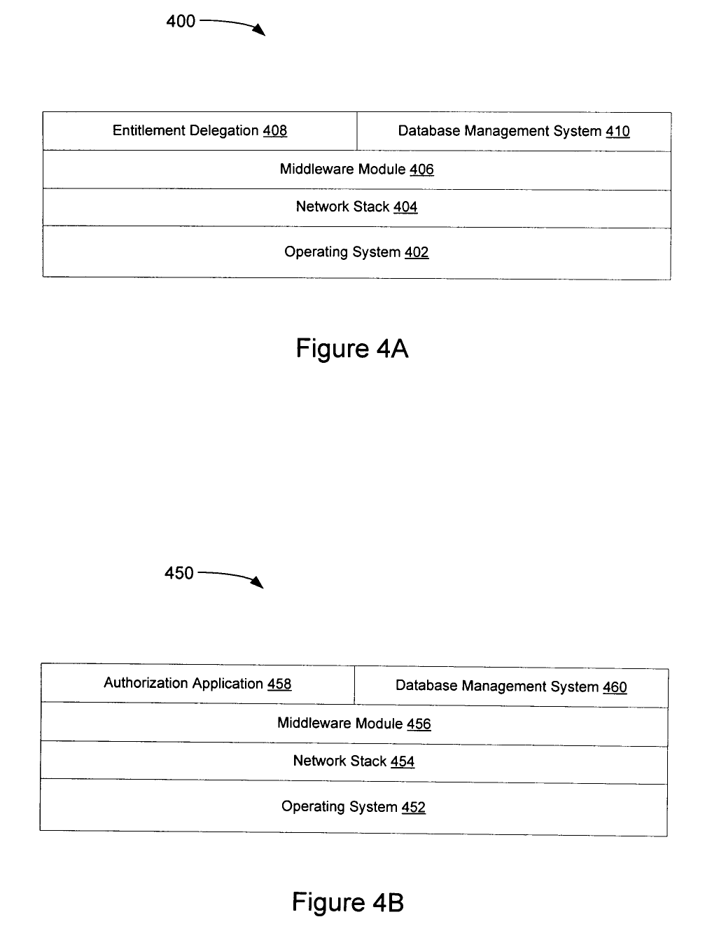

FIG. 4A is a diagrammatic representation of an embodiment of a software configuration 400 of change administrator server 102 depicted in FIGS. 1 and 2 that facilitates conditional entitlement configuration and enforcement in accordance with embodiments disclosed herein. Configuration 400 includes an operating system 402 that manages execution of a network stack 404 that provides for network communications. For example, network stack 404 may be implemented as a transmission control protocol/Internet protocol (TCP/IP) stack. A middleware module 406, such as Websphere Application Server(TM) manufactured by International Business Machines or the like, may be deployed and run on network stack 404 that facilitates set up and operation of an entitlement delegation module 408. Entitlement delegation module 408 includes logic for receiving entitlement parameters, e.g., conditional access configuration parameters, from administrator console 110 and may interface with a database management system 410 adapted to query and manipulate change administrator database 104. For example, database management system 410 may comprise SQL parser and optimizer routines or instruction sets adapted for interfacing with the particular implementation of change administrator database 104. In the illustrative configuration, delegation module 408 may receive entitlement parameters and formulate SQL operations that are conveyed to database management system 410 that, in turn, executes the operations on change administrator database 104. Database management system 410 may receive result sets from change administrator database 104 and convey the results to entitlement delegation module 408 for evaluation or other processing.

FIG. 4B is a diagrammatic representation of an embodiment of a software configuration 450 of operator console server 114 depicted in FIG. 1 that facilitates receipt, processing, and authorization of operator access requests. Software configuration 450 includes an operating system 452 that manages execution of a network stack 454 that provides for network communications. A middleware module 456 may be deployed and run on network stack 454 that facilitates set up and operation of an authorization application 458. Authorization application 458 includes logic for receiving operator access requests from operator console 112, evaluating the access requests, and returning access request results to operator console 112. To this end, authorization application 458 may interface with a database management system 460 adapted to interface and interrogate change administrator database 104. For example, authorization application 458 may receive an access request from an operator console, formulate an SQL operator therefrom, and submit the SQL operator to database management system 460. Database management system 460 may then process and execute the SQL operation on, for example, change administrator database 104, receive a result set therefrom, and convey the result set to authorization application 458 for evaluation or other processing. Authorization application 458 may then evaluate the result set and determine whether to grant or deny access to the operator, and a suitable notification may be generated and conveyed to the operator accordingly. In other implementations, administrator server 102 may be involved in the request authorization in conjunction with, or in lieu of, operator console server 114. In yet another embodiment, operator console server 114 and/or change administrator server 102 may interface with authentication directory 118 to determine whether an access request is to be granted or denied.

FIGS. 1-4B are intended as examples, and not as architectural limitations, of system, computer, and software configurations in which embodiments disclosed herein may be implemented. The particular system, computer architectures, and software configurations shown and described are illustrative and are chosen only to facilitate an understanding of the disclosed embodiments.

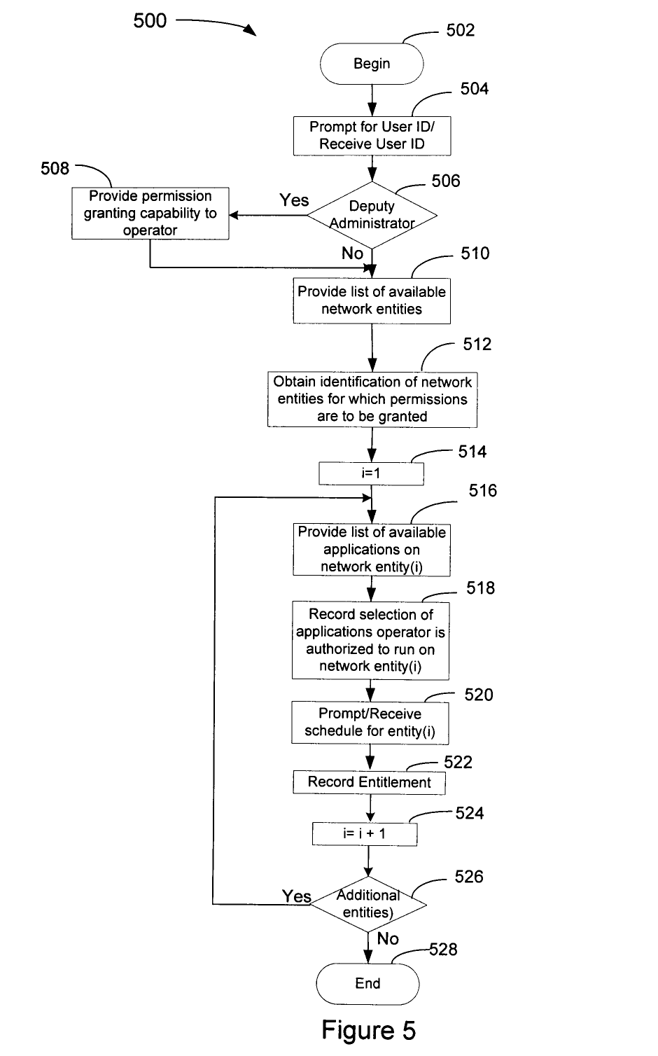

FIG. 5 is a flowchart 500 depicting processing of an embodiment of an entitlement delegation routine for allocating conditional entitlements. At step 502, the delegation routine is invoked, and, at step 504, a primary administrator is prompted for a user or operator identifier for which an entitlement is to be delegated. The operator identifier may, for example, be a user name assigned to an operator. At step 506, a prompt or evaluation may be made to determine if the user is to be delegated entitlement granting capabilities. As referred to herein, an operator having entitlement delegation granting capabilities is referred to as a deputy administrator. If the user is to be provided with entitlement granting capabilities, a permission granting capability designation is assigned or otherwise associated with the operator at step 508, and the delegation routine proceeds to provide a list of available network entities, such as names or other identifiers of managed network servers, at step 510. For example, the entitlement delegation routine may provide a menu of selectable items each including a respective name or other identifier of a network server.

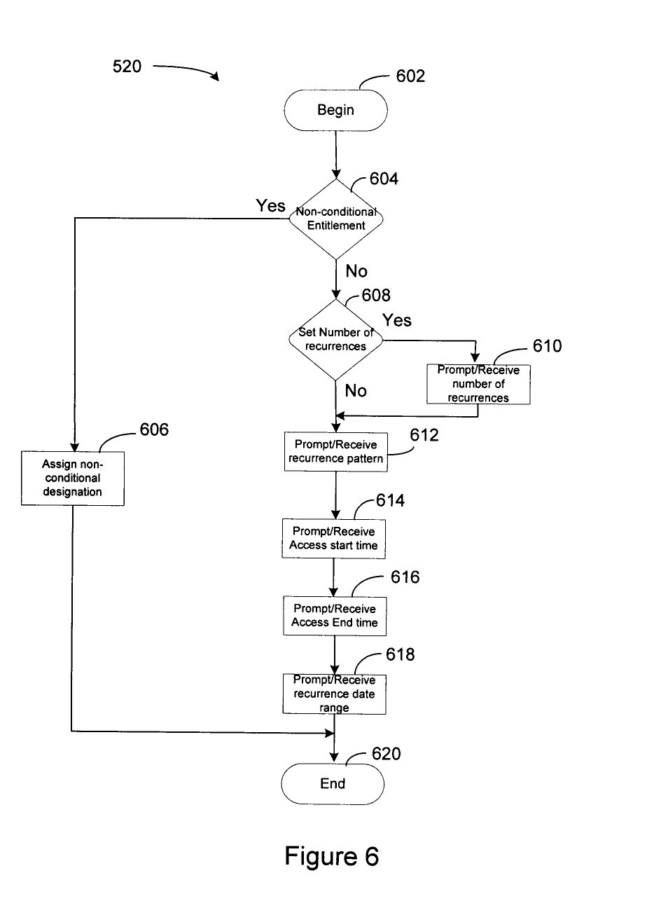

At step 512, the delegation routine obtains identification of one or more network entities to which the user is to be granted entitlements. At step 514, an index variable i may be initialized that facilitates configuration of each of the selected network entities for which entitlements are to be delegated to an operator. At step 516, a list of available applications that may be executed on a network entity(i) is provided to the primary administrator, and the entitlement delegation routine records any applications selected for authorized use by the operator on the network entity(i) at step 51 8. At step 520, a prompt is then provided for the primary administrator to supply schedule parameters for the entitlement being configured, and the entitlement delegation routine receives the schedule as described more fully hereinbelow with reference to FIG. 6. At step 522, the entitlement may be recorded, e.g., stored in database 104, and the index variable i may then be incremented at step 524. An evaluation may be made to determine if another network entity(i) is to be configured for the operator at step 526. In the event that an additional network entity(i) remains to be configured with an entitlement for the user, the delegation routine returns to step 516 to provide a list of available applications that may be run on the current network entity(i) selected for entitlement configuration. When all of the network entities selected for conditional or non-conditional access by the operator have been configured with an entitlement for the operator, the delegation routine cycle may end according to step 528.

FIG. 6 is a flowchart depicting an embodiment of the prompt and schedule receipt step 520 shown in FIG. 5 of an entitlement schedule configuration subroutine for assignment of a permission schedule to a conditional entitlement.

At step 602, the entitlement schedule configuration subroutine is invoked, and an evaluation may be made to determine whether the operator is to be given a non-conditional entitlement to the network entity at step 604. In the event that the operator is to be provided non-conditional or unrestricted access to the network entity, the schedule configuration subroutine may assign a non-conditional designation to the current entitlement being configured at step 606. The schedule configuration subroutine cycle may then end according to step 620.

Returning again to step 604, in the event that the operator is not to be delegated a non-conditional entitlement, the schedule configuration subroutine may then evaluate whether a maximum number of recurrences is to be set for the current entitlement according to step 608. In the event that a maximum number of recurrences are to be assigned for the entitlement being configured, the configuration subroutine may then prompt and receive a number or recurrences to be assigned to the entitlement at step 610. Notably, a one-time entitlement may be configured by setting a number of recurrences to 1 such that the entitlement will only be valid for a single use or period.

After the number of recurrences, if any, is provided, the configuration subroutine may proceed to prompt and receive a recurrence pattern for which the current entitlement is to be configured according to step 612. For example, a recurrence pattern may be set to a daily, weekly, monthly, yearly, or other suitable recurrence interval. At step 614, an access start time may be obtained, and an access end time may likewise be obtained by the configuration subroutine according to step 616. The access start time may define a start time, e.g., a time of day, at which the entitlement is to become active. In a similar manner, the access end time may define an end time at which the entitlement is to become inactive. In another embodiment, a duration value, rather than an end time, may be specified such that the entitlement is activated on authorized days at the start time for a duration specified by the duration value. The period between the start and end times comprises an active interval during which the entitlement is active on a day the operator is authorized to access the network entity associated with the entitlement. Additionally, the configuration subroutine may obtain a recurrence date range according to step 618. For example, a start date may be specified that identifies a date prior to which the entitlement is not to be activated. Likewise, an end date may be specified after which the entitlement is not to be activated. If the entitlement is to be delegated as an indefinite delegation, the end date may be nulled, non-specified, or otherwise ignored. The schedule configuration subroutine cycle may then end according to step 620.

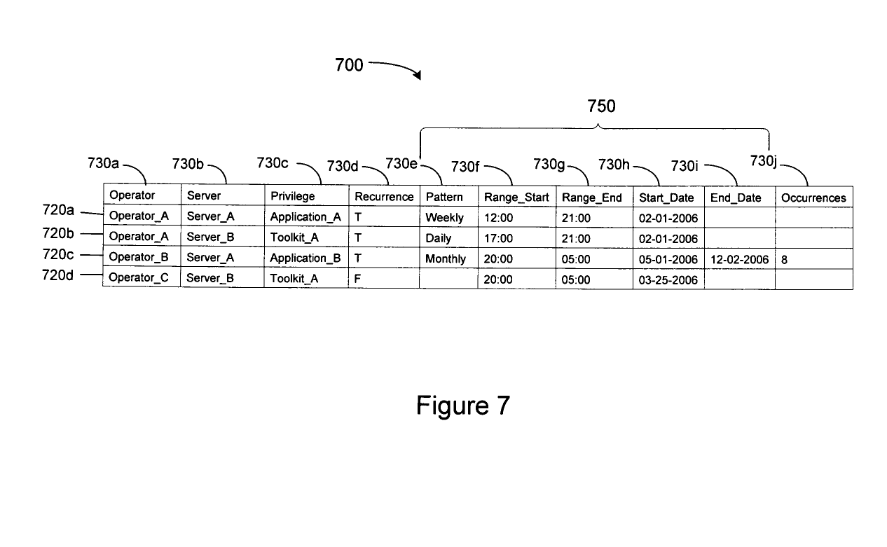

FIG. 7 depicts a diagrammatic representation of a table 700 comprising a plurality of records 720a-720d (collectively referred to as records 720) and fields 730a-730j (collectively referred to as fields 730) in which entitlements implemented in accordance with embodiments disclosed herein may be maintained. Table 700 may be stored on a disk drive or other suitable medium, fetched therefrom by a processor or other instruction processing device, and processed by a data processing system such as change administrator server 102 or operator console server 114 depicted in FIG. 1.

Fields 730 have a respective label, or identifier, that facilitates insertion, deletion, querying, or other data operations or manipulations of table 700. In the illustrative example, fields 730a-730j have respective labels of Operator, Server, Privilege, Recurrence, Pattern, Range_Start, Range_End, Start_Date, End_Date, and Occurrences. Each record 720a-720d defines an entitlement by association of various data element values recorded in fields 730a-730j, or a portion thereof, of a particular record.

In the illustrative example, data elements stored in Operator field 730a comprise operator names or other operator identifiers of operators for which entitlements are delegated in accordance with embodiments disclosed herein. Server field 730b may maintain data elements, such as server names, addresses, or other suitable identifiers, that identify network servers for which operational permissions are delegated for the corresponding entitlement or record. Privilege field 730c may maintain data elements that identify applications, operations, and/or other operational permissions that may be performed on a server identified in field 730b of an associated record. Recurrence field 730d may maintain a value that indicates whether the entitlement is of a recurrence type. For example, recurrence field 730d may have a Boolean value that, if asserted, indicates the entitlement is recurring. Pattern field 730e may store values that indicate the recurrence type, if any. For example, pattern field 730e may have a value that indicates a recurrence interval, e.g., hourly, daily, weekly, or another suitable time frame, of the entitlement recurrence. In the event that the entitlement is not configured for recurrence, pattern field 730e may be nulled. Range start and range end fields 730e and 730f may respectively store a value that indicates a start time at which the entitlement is valid and an end time at which the entitlement is invalid. Start date and end date fields 730h-730i respectively store data elements that specify a beginning date at which the entitlement may be valid and an end date, if any, at which date the entitlement expires. End date field 730i may be nulled if the entitlement is delegated indefinitely. Occurrences field 730j may store a value that defines a maximum number of occurrences that the entitlement may be valid if the entitlement is configured with an occurrence allowance. Occurrence field 730j may be nulled if no maximum number of occurrences is configured for the entitlement. Fields 730e-730i, or a portion thereof, collectively define a respective time-based schedule 750 for each of records 720a-720d.

In the present example, records 720a-720b each comprise entitlements delegated for an operator with an operator identifier (ID) of Operator_A, and records 720c-720d comprise an entitlement for a respective operator with an identifier of Operator_B and Operator_C as indicated by operator field 730a. Operator_A has conditional privileges for access to both Server_A and Server_B, each shown in FIG. 1, indicated by field 730b of entitlement records 720a-720b. Privilege field 730c restricts the access privilege of Operator_A to a single application designated Application_A on Server_A and to a set of applications designated Toolkit_A on Server_B. As referred to herein, a Toolkit comprises a set of one or more applications. For example, Toolkit_A may comprise a set of applications including applications designated Application_A and Application_B. A Boolean value of true, designated T, in field 730d specifies the entitlements defined by records 720a-720b are both recurring, and field 730e indicates the recurrence pattern of the entitlements defined by records 720a-720b are implemented on a respective weekly and daily interval. The range start and range end values of respective fields 730f and 730g indicate the access permission defined by record 720a is to be active beginning at a time of 12:00 through a time of 21:00. In a similar manner, the range start and range end values of respective fields 730f and 730g indicate the access permission defined by record 720b is to be active beginning at a time of 17:00 through a time of 21:00. The times specified by fields 730f-730g may be interpreted as GMT, another global time, or a local time. Field 730h specifies that both entitlements defined by records 720a-720b are set to activate on a date of Feb. 1, 2006. Field 730i of records 720a-720b is nulled thereby indicating that the entitlements defined by records 720a-720b are delegated indefinitely. That is, the entitlements defined by records 720a-720b do not have a defined date for expiration. Field 730j is nulled for both of records 720a-720b thereby indicating that the entitlements defined by records 720a-720b are not subject to a maximum occurrence limit.

Another operator with an operator ID of Operator_B has an entitlement that defines a conditional access permission to Server_A as indicated by fields 730a and 730b of record 720c. Field 730c of record 720c indicates Operator_B has an access privilege to Application_B. The entitlement defined by record 720c provides an access permission that recurs monthly as indicated by fields 730d and 730e. The range start and range end values of respective fields 730f and 730g indicate the access permission defined by record 720c is to be active beginning at a time of 20:00 through a time of 05:00. Fields 730h and 730i indicate the entitlement defined by record 720c is activated on May 1, 2006 and is set to expire on Dec. 2, 2006. Field 730j specifies that the entitlement defined by record 720d has a maximum occurrences value of 8.

Another operator with an operator ID of Operator_C has an entitlement that defines a conditional access permission to Server_B as indicated by fields 730a and 730b of record 720d. Field 730c of record 720c indicates Operator_C has an access privilege to a toolkit or application set designated Toolkit_A. The entitlement defined by record 720d provides a non-recurring access permission as indicated by field 730d, and thus no recurrence pattern is specified in field 730e. The range start and range end values of respective fields 730f and 730g indicate the access permission defined by record 720d is to be active beginning at a time of 20:00 through a time of 05:00. Field 730h indicates the entitlement defined by record 720d is activated on Mar. 25, 2006. Because the entitlement is non-recurring, no end date of the entitlement or number of occurrences are specified by fields 730i and 730j. Alternatively, an occurrence value of 1 may be specified in field 730j.

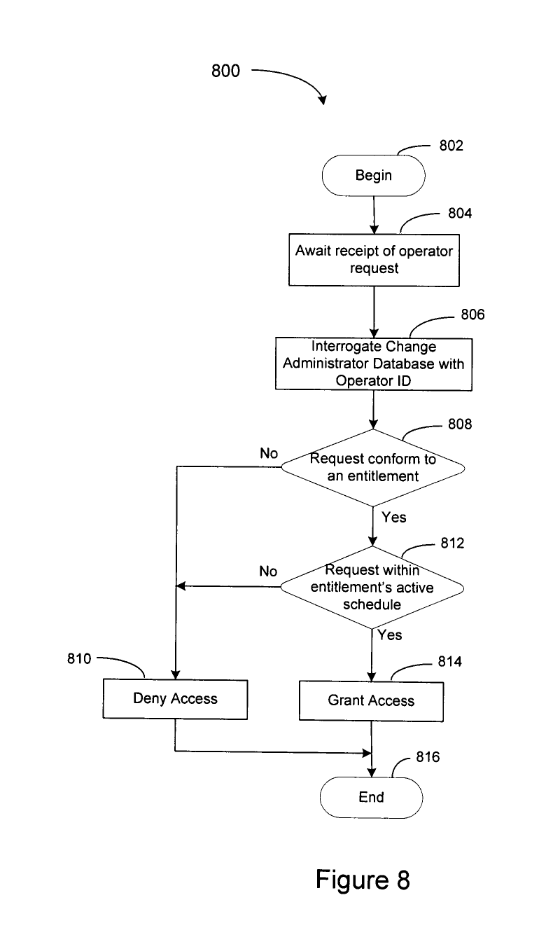

FIG. 8 is a flowchart 800 depicting processing steps of an authorization routine for authorizing operator requests in accordance with embodiments disclosed herein. At step 802, the authorization routine is invoked. On receipt of an access request, at step 804, the authorization routine may proceed to interrogate change administrator database 104 to facilitate evaluation of the request according to step 806. For example, the authorization routine may interrogate change administrator database 104 with an operator identifier. Additionally, other parameters may be used for interrogating change administrator database 104. In one implementation, the authorization routine may interrogate change administrator database 104 with an identifier of the server on which the operator has requested permission to perform one or more operations. In still another embodiment, the authorization routine may include an identifier of a specific application or operation the operator wishes to perform on a particular server. Other implementations for interrogating change administrator database 104 may be suitably implemented, and those described are chosen only to facilitate an understanding of embodiments disclosed herein.

At step 808, an evaluation may then be made to determine if the access request conforms to an entitlement. For example, table 700 may be interrogated to determine if the operator has any entitlement for the particular server on which the operator has requested access. In the event that the request does not conform to an entitlement, the authorization routine may proceed to deny the access request according to step 810. At step 816, the authorization routine cycle may then end.

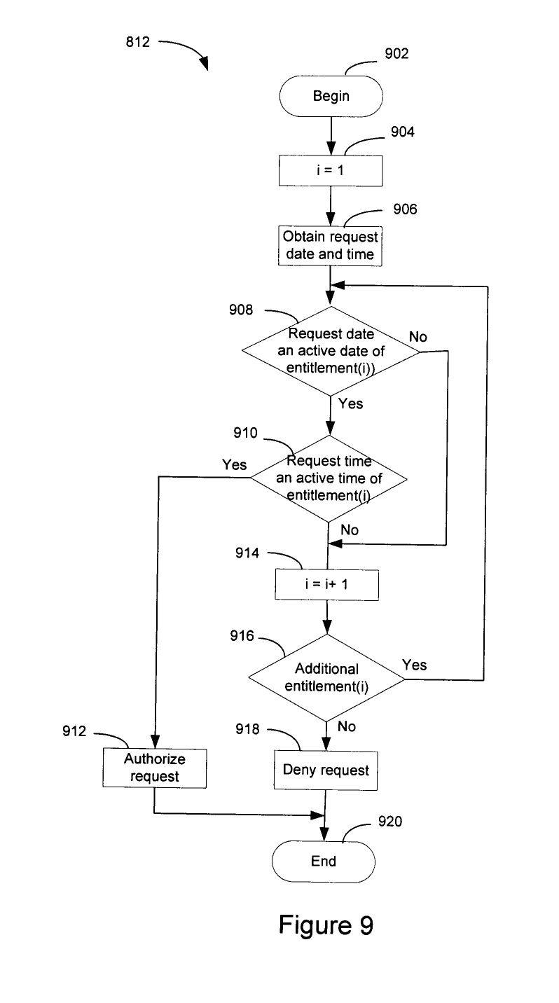

Returning again to step 808, in the event that the access request conforms to an entitlement, an evaluation may then be made to determine if the access request is within the active schedule of the entitlement according to step 812 and as described more fully hereinbelow with reference to FIG. 9. In the event that the access request is not within the active schedule, the authorization routine may deny access to the operator according to step 810. The authorization routine may proceed to grant access if the access request is made within the active schedule of the entitlement according to step 814, and the authorization routine cycle may then end according to step 816.

FIG. 9 is a flowchart of the schedule evaluation step 812 depicted in FIG. 8 of a schedule evaluation subroutine for evaluating an entitlement schedule in accordance with embodiments of the disclosure.

At step 902, the schedule evaluation subroutine is invoked, and an index i may be initialized to facilitate evaluation of one or more entitlements identified as conforming to the access request at step 904. The schedule evaluation subroutine may then obtain the access request date and time at step 906, and proceed to evaluate whether the access request date is an active date of the currently evaluated entitlement(i) at step 908. For example, the schedule evaluation subroutine may evaluate the schedule pattern and start date from respective fields 730e and 730h and determine if the request date corresponds to an active entitlement date. Additionally, the schedule evaluation subroutine may also evaluate the schedule end date obtained from field 730i to determine if the entitlement has expired. In the event that the request date does not conform to the date schedule parameters of entitlement(i), the schedule evaluation subroutine may proceed to increment the index variable i according to step 914.

Returning again to step 908, in the event that the request date conforms to the schedule date parameters of entitlement(i), the schedule evaluation subroutine may proceed to evaluate whether the request time is an active time of entitlement(i) at step 910, i.e., conforms to the schedule time parameters of entitlement(i). For example, the schedule evaluation subroutine may evaluate the schedule start time and end time obtained from respective fields 730f and 730g for entitlement(i) being evaluated. In the event that the request time falls between the start and end times, the schedule evaluation subroutine may proceed to authorize a request compliant with entitlement(i) at step 912. Otherwise, the schedule evaluation subroutine may then proceed to increment the index variable i according to step 914.

If either the request date or time has been identified as non-conformant with entitlement(i) and the index i has been incremented, an evaluation may be made to determine whether an additional entitlement(i) remains to be evaluated against the request according to step 916. If an additional entitlement(i) remains for evaluation, the subroutine may return to step 908 to determine whether the request date is an active date of the entitlement(i). Otherwise, the schedule evaluation subroutine may then deny the access request according to step 918, and the schedule evaluation subroutine cycle may then end according to step 920.

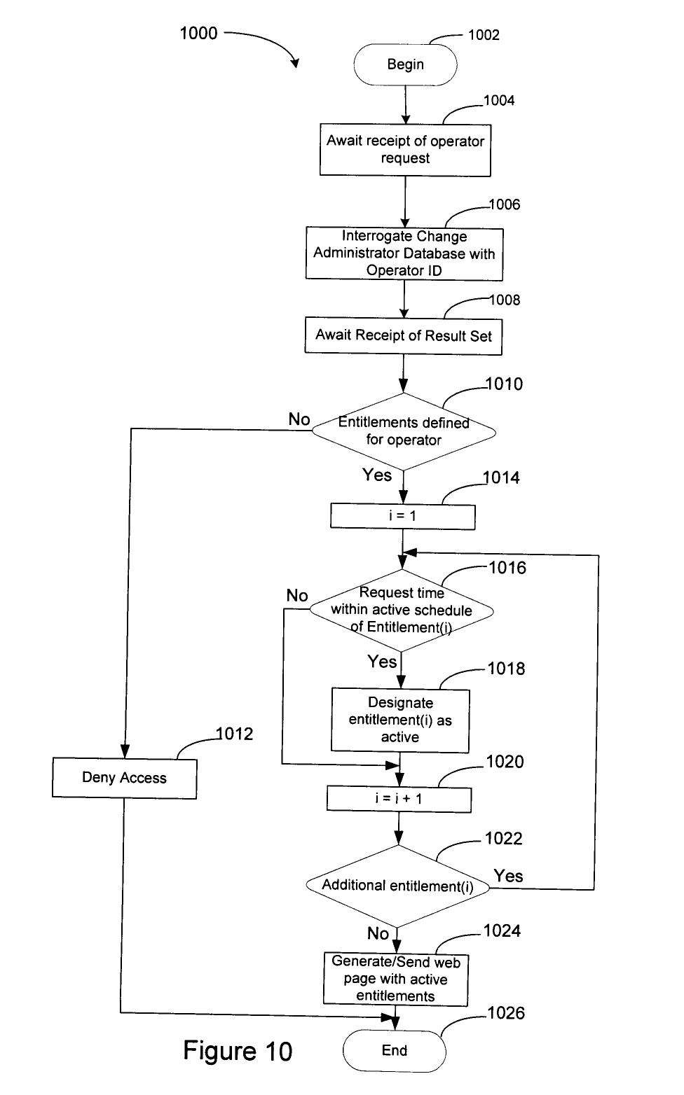

FIG. 10 is a flowchart depicting processing steps of an authorization routine for processing generic access requests in accordance with embodiments disclosed herein. At step 1002, the authorization routine is invoked. On receipt of a generic access request, at step 1004, the authorization routine may proceed to interrogate change administrator database 104 to facilitate evaluation of the request according to step 1006. For example, the authorization routine may interrogate change administrator database 104 with an operator identifier. At step 1008, the authorization routine awaits receipt of a result set. On receipt of the result set, the authorization routine may evaluate the result set to determine if any entitlements are defined for the operator according to step 1010. For example, assume that interrogation of change administrator database 104 is performed at step 1006 by executing an SQL SELECT command with the operator ID. In this implementation, if no records are returned in the result set, the authorization routine may determine that no entitlements are defined for the operator. In this instance, the authorization routine may deny access to the operator according to step 1012. Additionally, the authorization routine may notify the operator of the access denial, and the authorization routine cycle may then end according to step 1026.

Returning again to step 1010, in the event that one or more entitlements are defined for the operator, an entitlement index, i, may be initialized, and a first entitlement(i) may be evaluated to determine if the access request time is within the active schedule time of the entitlement(i) according to step 1016. In general, the evaluation of the access request time may be performed in a similar manner as that described above with reference to FIG. 9. If the request time is not within the active schedule of entitlement(i), the authorization routine may proceed to increment the index i according to step 1020. In the event that the request time is within the active schedule of entitlement(i), the authorization routine may designate entitlement(i) as active at step 101 8, and the authorization routine may then proceed to increment the index i according to step 1020.

After the index, i, is incremented at step 1020, an evaluation may be made to determine if another entitlement(i) remains for evaluation according to step 1022. In the event that an additional entitlement(i) remains for evaluation, the authorization routine may return to step 101 6 to evaluate the schedule of entitlement(i). When all entitlements have been evaluated, the authorization routine may generate and send a web page, or other suitable data structure, that provides an indication of the current active entitlements, if any, for the operator according to step 1024. For example, a web page may be generated with a menu of selectable items each associated with a server to which the operator may currently be granted access. On selection of a particular item by the operator, a log-in procedure and/or authorization routine may be invoked that provide access to the server or other entity designated in the selected item. Once the web page or other data structure is transmitted to the operator, the authorization routine cycle may end according to step 1026.

Returning again to FIGS. 1 and 7, consider an operator with an operator or user identifier designated Operator_A. In accordance with embodiments described herein, Operator_A would be allowed to access Server_A with operator privileges restricted to Application_A from 12:00 to 21:00 on Feb. 1, 2006. The same access privilege is available to Operator_A on a weekly basis, i.e., on Feb. 8, 2006, Feb. 13, 2006, etc. If Operator A requests access to Server A outside this recurring period, the operator's access request would be denied. In a similar manner, Operator_A may be granted access restricted to Toolkit_A on a daily basis from 17:00 to 21:00 beginning on Feb. 1, 2006.

Operator B may be granted access to Server_A that is restricted to Application_B on the first day of the month beginning on May 1, 2006. The same access privilege is available to Operator_A on a monthly basis, i.e., on Jun. 1, 2006, Jul. 1, 2006, etc. The operational access granted to Operator_B is restricted from 20:00 to 05:00 on the first day of each month. In accordance with the entitlement defined by record 720c, Operator_B has a maximum defined entitlement occurrence of 8, and the operator's access is set to expire on Dec. 2, 2006.

Operator_C may be granted access to Server_B from 20:00 to 05:00 on Mar. 25, 2006. Because the entitlement defined for Operator_C by record 720d is not recurring, the entitlement comprises a single use entitlement.

The authorization routines depicted in FIGS. 8-10 are illustrative only and are intended to facilitate an understanding of embodiments disclosed herein. Any variety of authorization mechanisms may be implemented for enforcing the conditional entitlements described herein. For example, just-in time proxy accounts may be configured in accordance with the conditional entitlements that facilitate time-based access privileges.

The flowcharts of FIGS. 5-6 and 8-10 depict process serialization to facilitate an understanding of disclosed embodiments and are not necessarily indicative of the serialization of the operations being performed. In various embodiments, the processing steps described in FIGS. 5-6 and 8-10 may be performed in varying order, and one or more depicted steps may be performed in parallel with other steps. Additionally, execution of some processing steps of FIGS. 5-6 and 8-10 may be excluded without departing from embodiments disclosed herein. The illustrative block diagrams and flowcharts depict process steps or blocks that may represent modules, segments, or portions of code that include one or more executable instructions for implementing specific logical functions or steps in the process. Although the particular examples illustrate specific process steps or procedures, many alternative implementations are possible and may be made by simple design choice. Some process steps may be executed in different order from the specific description herein based on, for example, considerations of function, purpose, conformance to standard, legacy structure, user interface design, and the like.

As described, a system, method, and computer-readable medium for delegating time-based permissions in a network system are provided. An operational permission assigned to an operator may be configured to provide conditional operational access to a network entity. In one embodiment, conditional access to the network entity is based on the time at which the operator requests access to the network entity. In other embodiments, recurring intervals during which access to the network entity may be defined. In this manner, a primary administrator may delegate operational permissions or privileges to network operators, and automated enforcement procedures determine whether an access request complies with, or violates, a time-based permission policy.

Embodiments disclosed herein provide a system, method, and computer-readable medium for delegating access permissions in a network system. An identifier of an operator and an identifier of a network entity on which the operator is to have operational privileges are provided. A schedule is associated with the operator and defines a time-based admission policy for allowing operational access to the network entity by the operator. In another embodiment, a recurrence pattern is specified that defines an interval over which the operator is to be allowed operational access to the network entity. The recurrence pattern may be selected from a group consisting of a daily interval, a weekly interval, a monthly interval, and a yearly interval. In another embodiment, an active period is defined during which the operator is to be allowed operational access to the network entity, and wherein the operator is to be denied operational access to the network entity at times not included in the active period. In another embodiment, the active period comprises a start time and an end time. In another embodiment, an end date after which the operator is to be denied operational access to the network entity is defined. In another embodiment, an entitlement is defined that associates the identifier of the operator, the identifier of the network entity, and the schedule. The entitlement may further associate an operational privilege with the identifier of the operator, the identifier of the network entity, and the schedule.

In accordance with another embodiment, a computer-readable medium for delegating access permissions in a network system is provided. The computer-readable medium includes instructions that receive an identifier of an operator, and an identifier of a network entity on which the operator is to have operational privileges. Instructions associate a schedule with the identifier of the operator. The schedule defines a time-based admission policy for allowing operational access to the network entity by the operator. In another embodiment, the instructions that associate the schedule further comprise instructions that specify a recurrence pattern that defines an interval over which the operator is to be allowed operational access to the network entity. The recurrence pattern may be selected from the group consisting of a daily interval, a weekly interval, a monthly interval, and a yearly interval. In another embodiment, the instructions that associate the schedule further comprise instructions that define an active period during which the operator is to be allowed operational access to the network entity. The operator is to be denied operational access to the network entity at times not included in the active period. In another embodiment, the instructions that define the active period further define an access start time and an access end time. In yet another embodiment, the computer-readable medium further comprises instructions that define an end date after which the operator is to be denied operational access to the network entity. In yet another embodiment, the computer-readable medium further comprises instructions that define an entitlement that associates the identifier of the operator, the identifier of the network entity, and the schedule. The entitlement may associate an operational privilege with the identifier of the operator, the identifier of the network entity, and the schedule.

In accordance with another embodiment, a system for delegating access permissions in a network system is provided. The system comprises an administrator server adapted to receive an identifier of an operator, an identifier of a network entity on which the operator is to have operational privileges, and a schedule that defines a time-based admission policy for allowing operational access to the network entity by the operator. Additionally, the system includes a database interfaced with the administrator server adapted to store the identifier of the operator, the identifier of the network entity, and the schedule. The schedule may comprise a recurrence pattern that defines an interval over which the operator is to be allowed operational access to the network entity. The recurrence pattern may be selected from the group consisting of a daily interval, a weekly interval, a monthly interval, and a yearly interval. The schedule may comprise an active period during which the operator is to be allowed operational access to the network entity. The operator is to be denied operational access to the network entity at times not included in the active period.

In accordance with another embodiment, a network access permission delegation system is provided. The system includes means for providing an identifier of an operator, means for providing an identifier of a network entity on which the operator is to have operational privileges, and means for associating a schedule with the operator that defines a time-based admission policy for allowing operational access to the network entity by the operator. The means for associating the schedule may further comprise means for specifying a recurrence pattern that defines an interval over which the operator is to be allowed operational access to the network entity. The recurrence pattern may be selected from the group consisting of a daily interval, a weekly interval, a monthly interval, and a yearly interval. In another embodiment, the means for associating the schedule may further comprise means for defining an active period during which the operator is to be allowed operational access to the network entity. The operator may be denied operational access to the network entity at times not included in the active period. The means for defining the active period may further comprise means for defining an access start time and an access end time. In another embodiment, the system may further comprise means for defining an end date after which the operator is to be denied operational access to the network entity. In another embodiment, the system may further comprise means for defining an entitlement that associates the identifier of the operator, the identifier of the network entity, and the schedule. The entitlement further associates an operational privilege with the identifier of the operator, the identifier of the network entity, and the schedule.

In another embodiment, a data structure tangibly embodied on a computer-readable medium that facilitates conditional access permissions in a network system is provided. The data structure comprises an identifier of an operator, an identifier of a network entity, and a schedule that defines a time-based policy for access to the network entity by the operator. The identifier of the operator, the identifier of the network entity, and the schedule may be stored in mutual association in the data structure. In one embodiment, the data structure comprises a table, and the identifier of the operator, the identifier of the network entity, and the schedule are commonly recorded in a record of the table.

In another embodiment, a method of delegating access permissions in a network system is provided. An identifier of an operator is recorded in a database record. An identifier of at least one application is recorded in the database record. An identifier of a network server is recorded in the database record on which the operator is to have a privilege comprising operational access of the application on the network server. An indicator is recorded in the record that indicates the privilege is to be recurring. A schedule is recorded in the record that defines an interval having a start time and an end time during which the operator is to be granted access to the network server and outside of which the operator is to be denied access to the server.

In another embodiment, a data structure tangibly embodied on a computer-readable medium that facilitates conditional access permissions in a network system is provided. The data structure comprises a field having an identifier of an operator, a field having an identifier of at least one application, a field having an identifier of a network server on which the operator is to have a privilege comprising operational access of the application on the network server, a field having an indicator that indicates the privilege is to be recurring, and at least one field having a schedule that defines an interval having a start time and an end time during which the operator is to be granted access to the network server and outside of which the operator is to be denied access to the server.

In accordance with another embodiment, a computer-readable medium having computer-executable instructions for execution by a processing system for delegating access permissions in a network system is provided. The computer-readable medium includes instructions that record, in a database record, an identifier of an operator, an identifier of at least one application, an identifier of a network server on which the operator is to have a privilege comprising operational access of the application on the network server, an indicator that indicates the privilege is to be recurring, and a schedule that defines an interval having a start time and an end time during which the operator is to be granted access to the network server and outside of which the operator is to be denied access to the server.

In accordance with another embodiment, a network access permission delegation system is provided. The system includes means for recording an identifier of an operator in a database record, means for recording an identifier of at least one application, means for recording an identifier of a network server in the database record on which the operator is to have a privilege comprising operational access of the application on the network server, means for recording an indicator in the record that indicates the privilege is to be recurring, and means for recording a schedule in the record that defines an interval having a start time and an end time during which the operator is to be granted access to the network server and outside of which the operator is to be denied access to the server.

In accordance with another embodiment, a system for delegating access permissions in a network system is provided. The system includes an administrator server adapted to receive an identifier of at least one application, an identifier of an operator, an identifier of a network server on which the operator is to have a privilege comprising operational access of the application on the network server, and a schedule that defines an interval having a start time and an end time during which the operator is to be granted access to the network server and outside of which the operator is to be denied access to the server. The system further includes a database interfaced with the administrator server that has a record including the identifier of the privilege, the identifier of the operator, the identifier of the network server, the schedule, and an indicator that indicates the privilege is to be recurring.

Aspects of the present invention may be implemented in software, hardware, firmware, or a combination thereof. The various elements of the system, either individually or in combination, may be implemented as a computer program product tangibly embodied in a machine-readable storage device for execution by a processing unit. Various steps of embodiments of the invention may be performed by a computer processor executing a program tangibly embodied on a computer-readable medium to perform functions by operating on input and generating output. The computer-readable medium may be, for example, a memory, a transportable medium such as a compact disk, a floppy disk, or a diskette, such that a computer program embodying the aspects of the present invention can be loaded onto a computer. The computer program is not limited to any particular embodiment, and may, for example, be implemented in an operating system, application program, foreground or background process, driver, network stack, or any combination thereof, executing on a single computer processor or multiple computer processors. Additionally, various steps of embodiments of the invention may provide one or more data structures generated, produced, received, or otherwise implemented on a computer-readable medium, such as a memory.

Although embodiments of the present disclosure have been described in detail, those skilled in the art should understand that they may make various changes, substitutions and alterations herein without departing from the spirit and scope of the present disclosure.

What is claimed is:

1. A method of delegating access permissions in a network system, comprising:
providing an identifier of an operator;
providing an identifier of a network entity on which the operator is to have operational privileges; and
associating a schedule with the operator that defines a time-based admission policy for allowing operational access to the network entity by the operator.

2. The method of claim 1, wherein associating a schedule further comprises specifying a recurrence pattern that defines an interval over which the operator is to be allowed operational access to the network entity.

3. The method of claim 2, wherein the recurrence pattern is selected from the group consisting of a daily interval, a weekly interval, a monthly interval, and a yearly interval.

4. The method of claim 1, wherein associating the schedule further comprises defining an active period during which the operator is to be allowed operational access to the network entity, and wherein the operator is to be denied operational access to the network entity at times not included in the active period.

5. The method of claim 4, wherein defining the active period further comprises defining an access start time and an access end time.

6. The method of claim 4, further comprising defining an end date after which the operator is to be denied operational access to the network entity.

7. The method of claim 1, further comprising defining an entitlement that associates the identifier of the operator, the identifier of the network entity, and the schedule.

8. The method of claim 7, wherein the entitlement further associates an operational privilege with the identifier of the operator, the identifier of the network entity, and the schedule.

9. A computer-readable medium having computer-executable instructions for execution by a processing system, the computer-executable instructions for delegating access permissions in a network system, comprising:
instructions that receive an identifier of an operator;
instructions that receive an identifier of a network entity on which the operator is to have operational privileges; and
instructions that associate a schedule with the identifier of the operator, wherein the schedule defines a time-based admission policy for allowing operational access to the network entity by the operator.

10. The computer-readable medium of claim 9, wherein the instructions that associate the schedule further comprise instructions that specify a recurrence pattern that defines an interval over which the operator is to be allowed operational access to the network entity.

11. The computer-readable medium of claim 10, wherein the recurrence pattern is selected from the group consisting of a daily interval, a weekly interval, a monthly interval, and a yearly interval.

12. The computer-readable medium of claim 9, wherein the instructions that associate the schedule further comprise instructions that define an active period during which the operator is to be allowed operational access to the network entity, and wherein the operator is to be denied operational access to the network entity at times not included in the active period.

13. The computer-readable medium of claim 12, wherein the instructions that define the active period further define an access start time and an access end time.

14. The computer-readable medium of claim 12, further comprising instructions that define an end date after which the operator is to be denied operational access to the network entity.

15. The computer-readable medium of claim 9, further comprising instructions that define an entitlement that associates the identifier of the operator, the identifier of the network entity, and the schedule.

16. The computer-readable medium of claim 15, wherein the entitlement further associates an operational privilege with the identifier of the operator, the identifier of the network entity, and the schedule.

17. A system for delegating access permissions in a network system, comprising:
an administrator server adapted to receive an identifier of an operator, an identifier of a network entity on which the operator is to have operational privileges, and a schedule that defines a time-based admission policy for allowing operational access to the network entity by the operator; and
a database interfaced with the administrator server adapted to store the identifier of the operator, the identifier of the network entity, and the schedule.

18. The system of claim 17, wherein the schedule further comprises a recurrence pattern that defines an interval over which the operator is to be allowed operational access to the network entity.

19. The system of claim 18, wherein the recurrence pattern is selected from the group consisting of a daily interval, a weekly interval, a monthly interval, and a yearly interval.

20. The system of claim 17, wherein the schedule further comprises an active period during which the operator is to be allowed operational access to the network entity, and wherein the operator is to be denied operational access to the network entity at times not included in the active period.

21. A network access permission delegation system, comprising:
means for providing an identifier of an operator;
means for providing an identifier of a network entity on which the operator is to have operational privileges; and
means for associating a schedule with the operator that defines a time-based admission policy for allowing operational access to the network entity by the operator.

22. The system of claim 21, wherein the means for associating the schedule further comprise means for specifying a recurrence pattern that defines an interval over which the operator is to be allowed operational access to the network entity.

23. The system of claim 22, wherein the recurrence pattern is selected from the group consisting of a daily interval, a weekly interval, a monthly interval, and a yearly interval.

24. The system of claim 21, wherein the means for associating the schedule further comprise means for defining an active period during which the operator is to be allowed operational access to the network entity, and wherein the operator is to be denied operational access to the network entity at times not included in the active period.

25. The system of claim 24, wherein the means for defining the active period further comprise means for defining an access start time and an access end time.

26. The system of claim 24, further comprising means for defining an end date after which the operator is to be denied operational access to the network entity.

27. The system of claim 21, further comprising means for defining an entitlement that associates the identifier of the operator, the identifier of the network entity, and the schedule.

28. The system of claim 27, wherein the entitlement further associates an operational privilege with the identifier of the operator, the identifier of the network entity, and the schedule.

29. A data structure tangibly embodied on a computer-readable medium that facilitates conditional access permissions in a network system, comprising:
an identifier of an operator;
an identifier of a network entity; and
a schedule that defines a time-based policy for access to the network entity by the operator.

30. The data structure of claim 29, wherein the identifier of the operator, the identifier of the network entity, and the schedule are stored in mutual association in the data structure.

31. The data structure of claim 30, wherein the data structure comprises a table, and wherein the identifier of the operator, the identifier of the network entity, and the schedule are commonly recorded in a record of the table.

32. A method of delegating access permissions in a network system, comprising:
recording an identifier of an operator in a database record;
recording an identifier of a privilege in the database record that specifies at least one application;
recording an identifier of a network server in the database record on which the operator is to have a privilege comprising operational access of the application on the network server;
recording an indicator in the record that indicates the privilege is to be recurring; and
recording a schedule in the record that defines an interval having a start time and an end time during which the operator is to be granted access to the network server and outside of which the operator is to be denied access to the server.

33. A data structure tangibly embodied on a computer-readable medium that facilitates conditional access permissions in a network system, comprising;
a field having an identifier of an operator;
a field having an identifier of at least one application;
a field having an identifier of a network server on which the operator is to have a privilege comprising operational access of the application on the network server;
a field having an indicator that indicates the privilege is to be recurring; and
at least one field having a schedule that defines an interval having a start time and an end time during which the operator is to be granted access to the network server and outside of which the operator is to be denied access to the server.

34. A computer-readable medium having computer-executable instructions for execution by a processing system, the computer-executable instructions for delegating access permissions in a network system, comprising:
instructions that record in a database record an identifier of an operator;
instructions that record in the database record an identifier of that specifies at least one application;
instructions that record in the database record an identifier of a network server on which the operator is to have a privilege comprising operational access of the application on the network server;
instructions that record in the database record an indicator that indicates the privilege is to be recurring; and
instructions that record in the database record a schedule that defines an interval having a start time and an end time during which the operator is to be granted access to the network server and outside of which the operator is to be denied access to the server.

35. A network access permission delegation system, comprising:
means for recording an identifier of an operator in a database record;
means for recording an identifier of at least one application;
means for recording an identifier of a network server in the database record on which the operator is to have a privilege comprising operational access of the application on the network server;
means for recording an indicator in the record that indicates the privilege is to be recurring; and
means for recording a schedule in the record that defines an interval having a start time and an end time during which the operator is to be granted access to the network server and outside of which the operator is to be denied access to the server.

36. A system for delegating access permissions in a network system, comprising:
an administrator server adapted to receive an identifier of at least one application, an identifier of an operator, an identifier of a network server on which the operator is to have a privilege comprising operational access of the application on the network server, a schedule that defines an interval having a start time and an end time during which the operator is to be granted access to the network server and outside of which the operator is to be denied access to the server; and
a database interfaced with the administrator server that has a record including the identifier of the application, the identifier of the operator, the identifier of the network server, the schedule, and an indicator that indicates the privilege is to be recurring.
